(19) United States
(12) Patent Application Publication
(10) Pub. No.: US 2016/0070580 A1
(43) Pub. Date: Mar. 10, 2016

(54) DIGITAL PERSONAL ASSISTANT REMOTE INVOCATION

(71) Applicant: Microsoft Technology Licensing, LLC, Redmond, WA (US)

(72) Inventors: Jeffrey Jay Johnson, Bellevue, WA (US); Murari Sridharan, Sammamish, WA (US); Gurpreet Virdi, Redmond, WA (US)

(73) Assignee: Microsoft Technology Licensing, LLC, Redmond, WA (US)

(21) Appl. No.: 14/481,821

(22) Filed: Sep. 9, 2014

(51) Int. Cl. G06F 9/44; G10L 17/22; G06F 3/16; G10L 15/00; H04L 29/08; G06F 17/30

(52) U.S. Cl. CPC G06F 9/4446; H04L 67/141; G06F 17/30554; G06F 3/167; G10L 15/00; G10L 17/22

(57) ABSTRACT

One or more techniques and/or systems are provided for providing personal assistant information. For example, a primary device (e.g., a smart phone) may establish a communication channel with a secondary device (e.g., a television that lacks digital personal assistant functionality). The primary device may receive a context associated with a user (e.g., a user statement “show weather on my television”). The primary device, which may be enabled with the digital personal assistant functionality or access to such functionality, may invoke the digital personal assistant functionality to evaluate the context to generate a personal assistant result (e.g., local weather information). The personal assistant result may be provided from the primary device to the secondary device for presentation to the user. In this way, the secondary device appears to provide digital personal assistant functionality even though the secondary device does not comprise or have access to such functionality.

### BACKGROUND

Many users may interact with various types of computing devices, such as laptops, tablets, personal computers, mobile phones, kiosks, videogame systems, etc. In an example, a user may utilize a mobile phone to obtain driving directions, through a map interface, to a destination. In another example, a user may utilize a store kiosk to print coupons and lookup inventory through a store user interface.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for remotely providing personal assistant information through a secondary device and/or for providing personal assistant information remotely received from a primary device are provided herein. In an example of remotely providing personal assistant information through a secondary device, a primary device may be configured to establish a communication channel with a secondary device. The primary device may receive a context associated with a user. The primary device may invoke digital personal assistant functionality to evaluate the context to generate a personal assistant result. The primary device may provide the personal assistant result to the secondary device for presentation to the user.

In an example of providing personal assistant information remotely received from a primary device, a secondary device may be configured to detect a context associated with a user. The secondary device may be configured to establish a communication channel with a primary device. The secondary device may be configured to send a message to the primary device. The message may comprise the context and an instruction for the primary device to invoke digital personal assistant functionality to evaluate the context to generate a personal assistant result. The secondary device may be configured to receive the personal assistant result from the primary device. The secondary device may be configured to present the personal assistant result to the user.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of remotely providing personal assistant information through a secondary device.

FIG. 2A is a component block diagram illustrating an exemplary system for remotely providing personal assistant information through a secondary device.

FIG. 2B is a component block diagram illustrating an exemplary system for remotely providing personal assistant information through a secondary device based upon interactive user feedback with a personal assistant result.

FIG. 3 is a component block diagram illustrating an exemplary system for remotely providing personal assistant information through a secondary device.

FIG. 4 is a component block diagram illustrating an exemplary system for providing personal assistant information remotely received from a primary device.

FIG. 5 is a component block diagram illustrating an exemplary system for concurrently presenting a personal assistant result through a first digital personal assistant user interface hosted on a secondary device and presenting a second personal assistant result through a second digital personal assistant user interface hosted on a primary device.

FIG. 6 is an illustration of an exemplary computer readable medium wherein processor-executable instructions configured to embody one or more of the provisions set forth herein may be comprised.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

One or more systems and/or techniques for remotely providing personal assistant information through a secondary device and/or for providing personal assistant information remotely received from a primary device are provided herein. Users may desire to access a digital personal assistant from various devices (e.g., the digital personal assistant may provide recommendations, answer questions, and/or facilitate task completion). Unfortunately, many devices may not have the processing capabilities, resources, and/or functionality to host and/or access the digital personal assistant. For example, appliances (e.g., a refrigerator), wearable devices (e.g., a smart watch), a television, and/or computing devices that do not have a version of an operation system that supports digital personal assistant functionality and/or an installed application associated with digital personal assistant functionality (e.g., a tablet, laptop, personal computer, smart phone, or other device that may not have an updated operating system version that supports digital personal assistant functionality) may be unable to provide users with access to the digital personal assistant. Accordingly, as provided herein, a primary device, capable of providing digital personal assistant functionality, may invoke the digital personal assistant functionality to evaluate a context associated with a user (e.g., a question posed by the user regarding the current weather) to generate a personal assistant result that is provided to a secondary device that does not natively support the digital personal assistant functionality. Because the primary device may be capable of invoking the digital personal assistant functionality (e.g., a smart phone comprising a digital personal assistant application and/or compatible operating system), the primary device may provide personal assistant results to the secondary device (e.g., a television) that may not be capable of invoking the digital personal assistant (e.g., current weather information may be provided from the primary device to the secondary device for display to the user). One or more of the techniques provided herein thus allow a primary device to provide personal assistant results to one or more secondary devices that would otherwise be incapable of generating and/or obtaining such results due to hardware and/or software limitations.

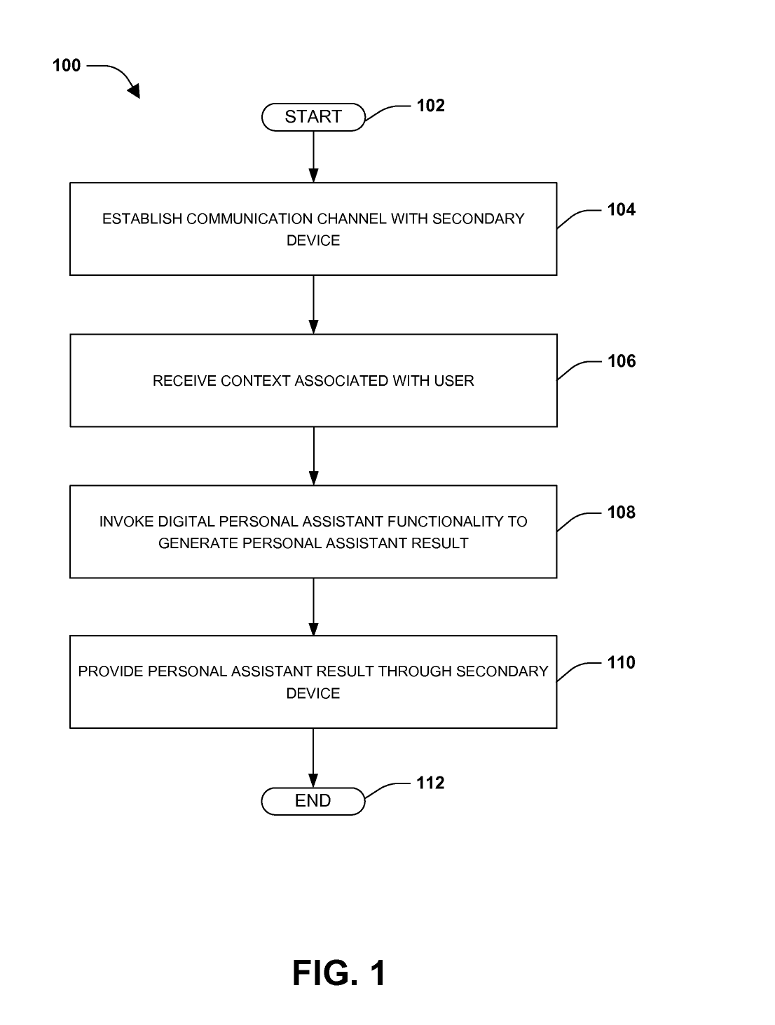

An embodiment of remotely providing personal assistant information through a secondary device is illustrated by an exemplary method 100 of FIG. 1. At 102, the method starts. At 104, a primary device may establish a communication channel with a secondary device. The primary device may be configured to natively support digital personal assistant functionality (e.g., a smart phone, a tablet, etc.). The secondary device may not natively support the digital personal assistant functionality (e.g., an appliance such as a refrigerator, a television, an audio visual device, a vehicle device, a wearable device such as a smart watch or glasses, or a non-personal assistant enabled device, etc.). In an example, the communication channel may be a wireless communication channel (e.g., Bluetooth). In an example, a user may walk past a television secondary device while holding a smart phone primary device, and thus the communication channel may be established (e.g., automatically, programmatically, etc.).

At 106, a context associated with the user may be received by the primary device. For example, the user may say “please purchase tickets to the amusement park depicted in the movie that is currently playing on my television”, which may be received as the context. In an example, the context may comprise identification information about the movie (e.g., a screen shot of the movie captured by the television secondary device; channel and/or time information that may be used to identify a current scene of the movie during which the amusement park is displayed; etc.) that may be used to perform image recognition for identifying the amusement park. In an example, the context may be received from the secondary device. For example, a microphone of the television secondary device may record the user statement as an audio file. The smart phone primary device may receive the audio file from the television secondary device as the context. Speech recognition may be performed on the audio file to generate a user statement context. In an example, the primary device may detect the context (e.g., a microphone of the smart phone primary device may detect the user statement as the context).

In an example, context may comprise audio data (e.g., the user statement “please purchase tickets to the amusement park depicted in the movie that is currently playing on my television”), video data (e.g., the user may perform a gesture that may be recognized as a check for new emails command context), imagery (e.g., the user may place a consumer item in front of a camera, which may be detected as a check price command context), or other sensor data (e.g., a camera within a refrigerator may indicate what food is (is not) in the refrigerator and thus what food the user may (may not) need to purchase; a temperate sensor of a house may indicate a potential fire; a door sensor may indicate that a user entered or left the house; a car sensor may indicate that the car is due for an oil change; etc.) that may be detected by various sensors that may be either separate from a primary device and a secondary device or may be integrated into a primary device and/or a secondary device.

At 108, the primary device may invoke digital personal assistant functionality to evaluate the context to generate a personal assistant result. In an example, the smart phone primary device may comprise an operating system and/or a digital personal assistant application that is capable of accessing and/or invoking a remote digital personal assistant service to evaluate the context. In another example, the smart phone primary device may comprise a digital personal assistant application comprising the digital personal assistant functionality. The digital personal assistant functionality may not be hosted by and/or invokeable by the television secondary device. In an example, the personal assistant result may comprise an audio message (e.g., a ticket purchase confirmation message), a text string (e.g., a ticket purchase confirmation statement), an image (e.g., a depiction of various types of tickets for purchase), a video (e.g., driving directions to the amusement park), a website (e.g., an amusement park website), task completion functionality (e.g., an ability to purchase tickets for the amusement park), a recommendation (e.g., a hotel recommendation for a hotel near the amusement park), a text to speech string (e.g., raw text, understandable by the television secondary device, without speech synthesis markup language information), an error string (e.g., a description of an error condition corresponding to the digital personal assistant functionality incurring an error in evaluating the context), etc.

At 110, the personal assistant result may be provided, by the primary device, to the secondary device for presentation to the user. The primary device may invoke the secondary device to display and/or play (e.g., play audio) the personal assistant result through the secondary device. For example, the smart phone primary device may provide a text string “what day and how many tickets would you like to purchase for the amusement park?” to the television secondary device for display on the television secondary device. In an example, interactive user feedback for the personalized assistant result may be received, by the primary device, from the secondary device. For example, the television secondary device may record a second user statement “I want 4 tickets for this Monday”, and may provide the second user statement to the smart phone primary device. The smart phone primary device may invoke the digital personal assistant functionality to evaluate the interactive user feedback to generate a second personal assistant result (e.g., a ticket purchase confirmation number). The smart phone primary device may provide the second personal assistant result to the television secondary device for presentation to the user.

In an example, the primary device may locally provide personal assistant results concurrently with the secondary device providing the personal assistant result. For example, the smart phone primary device may invoke the television secondary device to present the personal assistant result (e.g., the text string “what day and how many tickets would you like to purchase for the amusement park?”) through a first digital personal assistant user interface (e.g., a television display region) hosted on the television secondary device. The smart phone primary device may concurrently present the personal assistant result (e.g., the text string “what day and how many tickets would you like to purchase for the amusement park?”) through a second digital personal assistant user interface (e.g., an audio playback interface of the text string, a visual presentation of the text string, etc.) hosted on the smart phone primary device.

Different personal assistant results may be presented concurrently on the primary device and the secondary device. For example, the secondary device may be invoked to present a first personal assistant result (e.g., the text string “what day and how many tickets would you like to purchase for the amusement park?”) while the primary device may concurrently present a second personal assistant result (e.g., an audio or textual message “the weather will be sunny”, which is generated by the digital personal assistant functionality in response to a user statement “please show me the weather for Monday on my phone” (e.g., where the user statement regarding the weather occurs close in time to the user statement regarding purchasing tickets to the amusement park)). In this way, one or more personal assistant results may be provided to the user through the secondary device and/or concurrently through the primary device based upon the primary device invoking the digital personal assistant functionality. At 112, the method ends. It will be appreciated that a user may consent to activities presented herein, such as a context associated with a user being used to generate a personal assistant result. For example, a user may provide opt in consent (e.g., by responding to a prompt) allowing the collection and/or use of signals, data, information, etc. associated with the user for the purposes of generating a personal assistant result (e.g., that may be displayed on a primary device and/or one or more secondary devices). For example, a user may consent to GPS data from a primary device being collected and/or used to determine weather, temperature, etc. conditions for a location associated with the user.

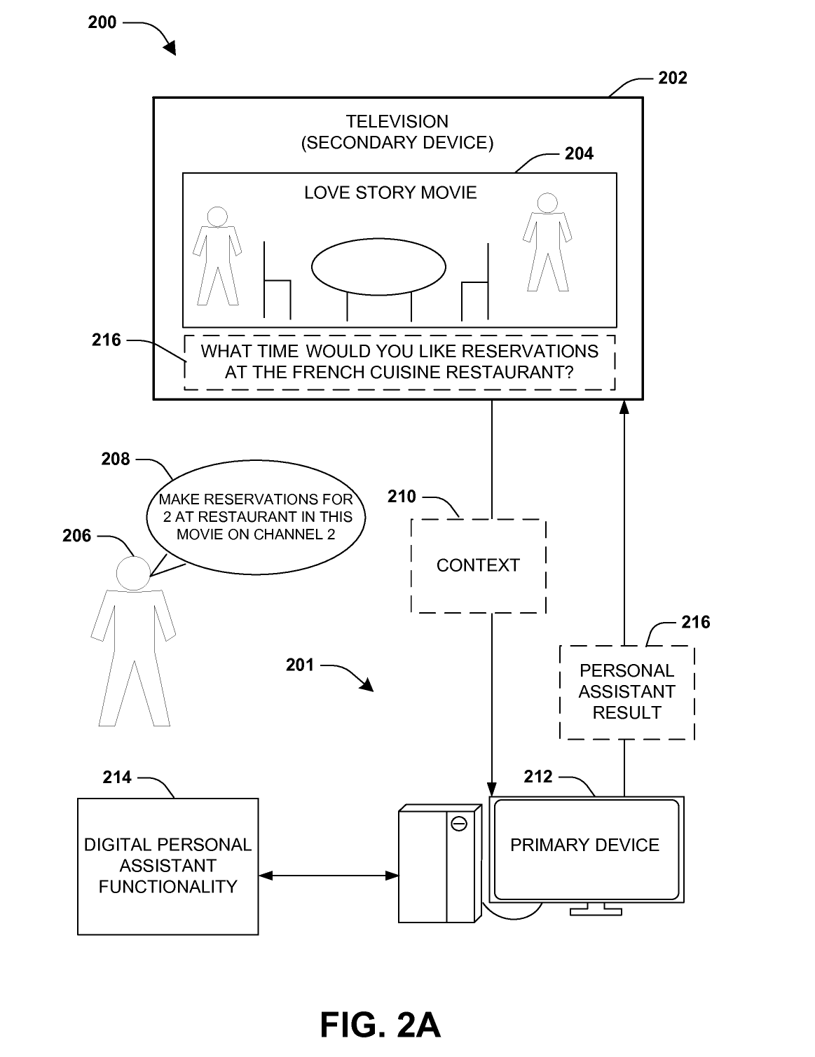

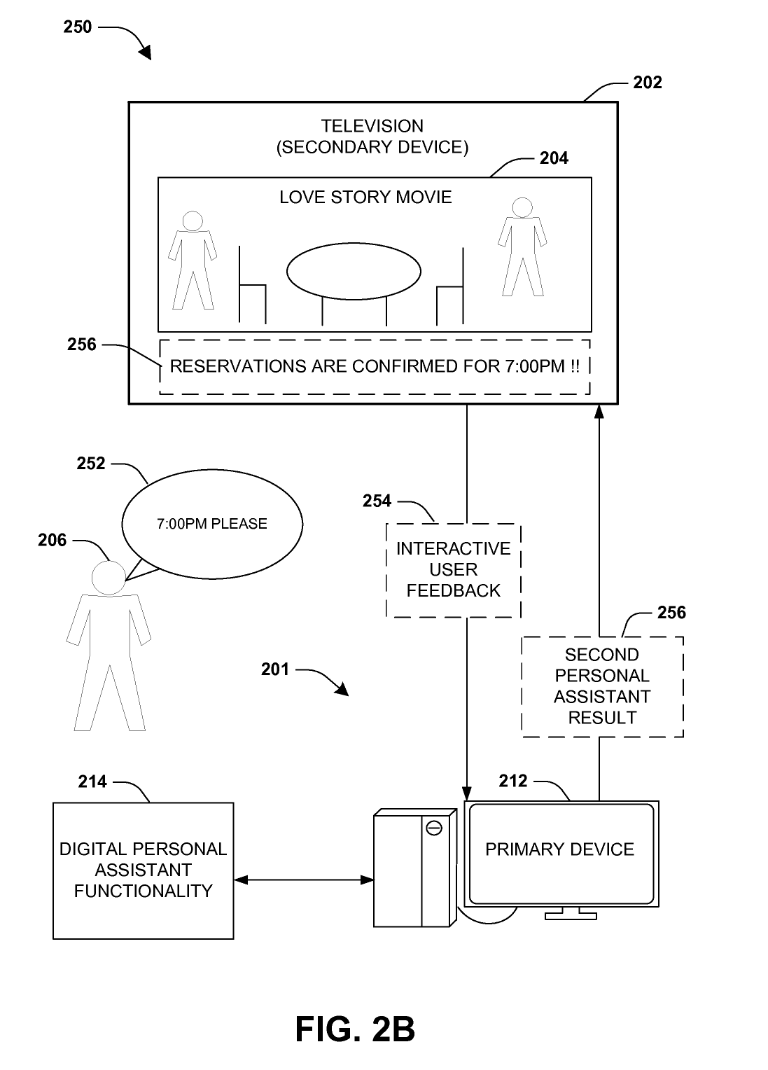

FIGS. 2A-2B illustrate examples of a system 201, comprising a primary device 212, for remotely providing personal assistant information through a secondary device. FIG. 2A illustrates an example 200 of the primary device 212 establishing a communication channel with a television secondary device 202. The primary device 212 may receive a context 210 associated with a user 206 from the television secondary device 202. For example, television secondary device 202 may detect a first user statement 208 “make reservations for 2 at the restaurant in this movie on channel 2”. The television secondary device 202 may include the first user statement 208 within the context 210. In an example, the television secondary device 202 may include, within the context 210, a screen capture of a Love Story Movie 204 currently displayed by the television secondary device 202 and/or other identifying information that may be used by digital personal assistant functionality to identify a French Cuisine Restaurant in the Love Story Movie 204.

The primary device 212 may be configured to invoke the digital personal assistant functionality 214 to evaluate the context 210 to generate a personal assistant result 216. In an example, the primary device 212 may locally invoke the digital personal assistant functionality 214 where the digital personal assistant functionality 214 is locally hosted on the primary device 212. In another example, the primary device 212 may invoke a digital personal assistant service, remote from the primary device 212, to evaluate the context 210. In an example, the personal assistant result 216 may comprise a text string “what time would you like reservations at the French Cuisine Restaurant?”. The primary device 212 may provide the personal assistant result 216 to the television secondary device 202 for presentation to the user 206.

FIG. 2B illustrates an example 250 of the primary device 212 receiving interactive user feedback 254 for the personal assistant result 216 from the television secondary device 202. For example, the television secondary device 202 may detect a second user statement 252 “7:00 PM please” as the interactive user feedback 254, and may provide the interactive user feedback 254 to the primary device 212. The primary device 212 may invoke the digital personal assistant functionality 214 (e.g., that is local to and/or remote from the primary device 212) to evaluate the interactive user feedback 254 to generate a second personal assistant result 256. For example, the second personal assistant result 256 may comprise a second text string “Reservations are confirmed for 7:00 PM !!”. The primary device 212 may provide the second personal assistant result 256 to the television secondary device 202 for presentation to the user 206.

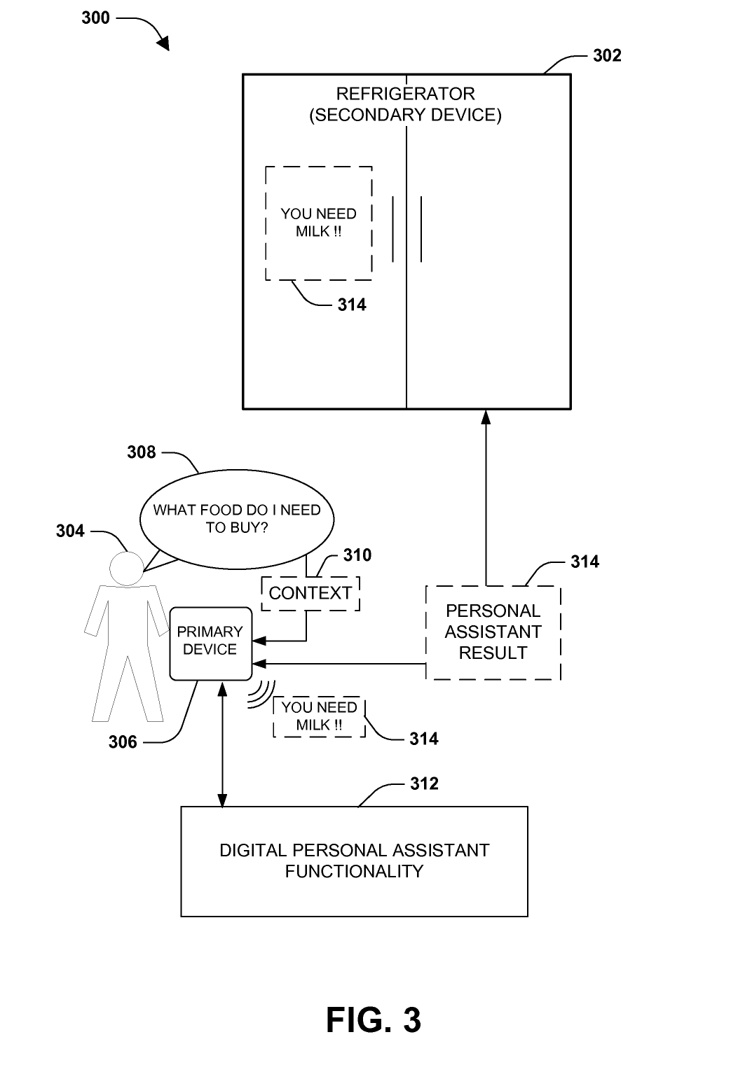

FIG. 3 illustrates an example of a system 300 for remotely providing personal assistant information through a secondary device. The system 300 may comprise a primary device, such as a smart phone primary device 306, which may establish a communication connection with a secondary device, such as a refrigerator secondary device 302. The smart phone primary device 306 may receive a context 310 associated with a user 304. For example, a microphone of the smart phone primary device 306 may detect a user statement “what food do I need to buy?” from the user 304. In an example, the smart phone primary device 306 may define a context recognition enablement policy that is to be satisfied in order for the context 310 to be detected as opposed to ignored (e.g., the context recognition enablement policy may specify that the context may be detected so long as the smart phone primary device 306 is not in a phone dial mode and that text messaging is off, which may be satisfied or not by a current situation context of the smart phone primary device 306). In an example, the smart phone primary device 306 may obtain additional information from the refrigerator secondary device 302 and/or from other sensors as the context 310 (e.g., the smart phone primary device 306 may invoke a camera sensor within the refrigerator secondary device 312 and/or a camera sensor within a cupboard to detect what food is missing that the user 304 may have registered as normally keeping in stock).

The smart phone primary device 306 may invoke digital personal assistant functionality 312 (e.g., hosted locally on the smart phone primary device 306 and/or hosted by a remote digital personal assistant service) to evaluate the context 310 to generate a personal assistant result 314. For example, the digital personal assistant functionality 312 may determine (e.g., via image/object recognition) that imagery captured by the refrigerator secondary device 302 indicates that the user 304 is low or out of milk, and thus the personal assistant result 314 may comprise a display message “You need milk !!”. The smart phone primary device 306 may provide the personal assistant result 314 to the refrigerator secondary device 302 for presentation to the user 304 (e.g., for display or audio playback). Additionally or alternatively, the personal assistant result 314 may be presented to the user via the primary device 306 (e.g., as an audio message played from the primary device 306 and/or a textual message displayed on the primary device 306).

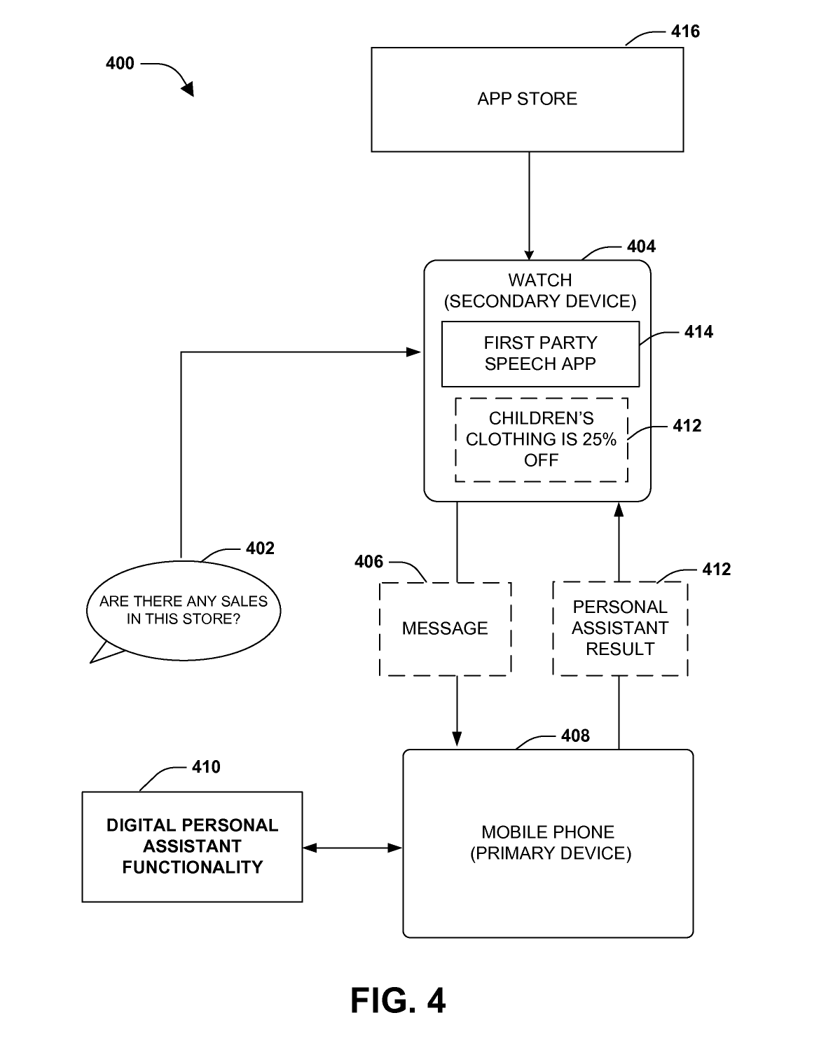

FIG. 4 illustrates an example of a system 400 for providing personal assistant information remotely received from a primary device. The system 400 may comprise a secondary device, such as a watch secondary device 404. The watch secondary device 404 may be configured to detect a context associated with a user. For example, a microphone of the watch secondary device 404 may detect a user statement 402 “Are there any sales in this store?” as the context. In an example, the watch secondary device 404 may have detected the user statement using a first party speech app 414 retrieved from an app store 416. In an example, the watch secondary device 404 may define a context recognition enablement policy that is to be satisfied in order for the context to be detected as opposed to ignored (e.g., the context recognition enablement policy may specify that the context may be detected so long as the watch secondary device 404 is not in a phone dial mode and that text messaging is off, which may be satisfied or not by a current situation context of the watch secondary device 404). In an example, a current location of the user, such as a retail store, may be detected (e.g., via GPS, Bluetooth beacons, etc.) for inclusion within the context.

The watch secondary device 404 may establish a communication channel with a primary device, such as a mobile phone primary device 408. The watch secondary device 404 may send a message 406 to the mobile phone primary device 408. The message 406 may comprise the context (e.g., audio data of the user statement, current location of the user, etc.) and/or an instruction for the mobile phone primary device 408 to invoke digital personal assistant functionality 410 (e.g., that is local to and/or remote from the mobile phone primary device 408) to evaluate the context to generate a personal assistant result 412. For example, the personal assistant result 412 may comprise a text string and/or a text to speech string “Children's clothing is 25% off”. The watch secondary device 404 may receive the personal assistant result 412 from the mobile phone primary device 408. The watch secondary device 404 may present the personal assistant result 412 (e.g., display the text string; play the text to speech string; etc.) to the user.

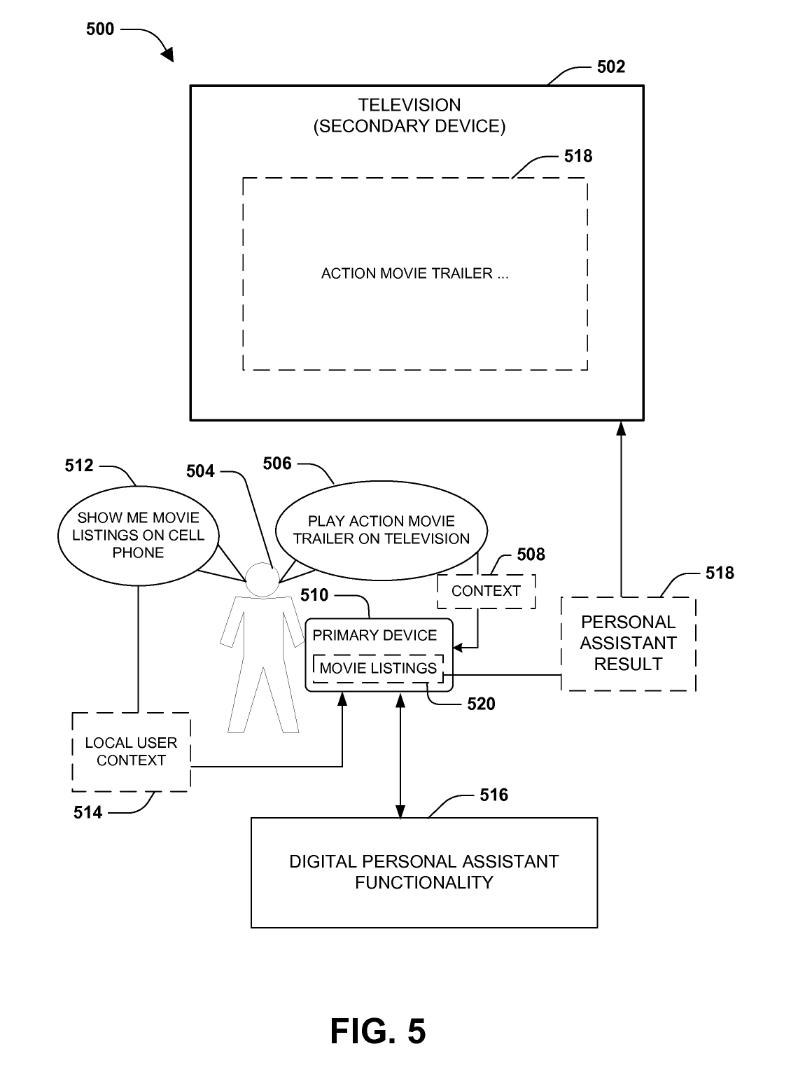

FIG. 5 illustrates an example of a system 500 for concurrently presenting a personal assistant result 518 through a first digital personal assistant user interface hosted on a secondary device and presenting a second personal assistant result 520 through a second digital personal assistant user interface hosted on a primary device 510. The primary device 510 (e.g., a cell phone) may establish a communication channel with a television secondary device 502. The primary device 510 may receive a context 508 associated with a user 504. For example, primary device 510 may detect a first user statement 506 “Play Action Movie trailer on television” as the context 508 that is directed towards providing personal assistant information on the television secondary device 502. The primary device 510 may be configured to invoke digital personal assistant functionality 516 (e.g., that is local to and/or remote from the primary device 510) to evaluate the context 508 to generate a personal assistant result 518, such as the Action Movie trailer. The primary device 510 may provide the personal assistant result 518 to the television secondary device 502 for presentation to the user 504 through the first digital personal assistant user interface (e.g., a television display region of the television secondary device 502).

The primary device 510 may detect a second user statement 512 “show me movie listings on cell phone” as a local user context 514 that is directed towards providing personal assistant information on the primary device 510. The primary device 510 may be configured to invoke the digital personal assistant functionality 516 to evaluate the local user context 514 to generate a second personal assistant result 520, such as the movie listings. The primary device 510 may present the second personal assistant result 520 through the second digital personal assistant user interface on the primary device 510 (e.g., a digital personal assistant app deployed on the cell phone). In an example, the personal assistant result 518 may be presented through the first digital personal assistant user interface of the television secondary device 502 concurrently with the second personal assistant result 520 being presented through the second digital personal assistant user interface of the primary device 510.

According to an aspect of the instant disclosure, a system for remotely providing personal assistant information through a secondary device is provided. The system includes a primary device. The primary device is configured to establish a communication channel with a secondary device. The primary device is configured to receive a context associated with a user. The primary device is configured to invoke digital personal assistant functionality to evaluate the context to generate a personal assistant result. The primary device is configured to provide the personal assistant result to the secondary device for presentation to the user.

According to an aspect of the instant disclosure, a system for providing personal assistant information remotely received from a primary device. The system includes a secondary device. The secondary device is configured to detect a context associated with a user. The secondary device is configured to establish a communication channel with a primary device. The secondary device is configured to send a message to the primary device. The message comprises the context and an instruction for the primary device to invoke digital personal assistant functionality to evaluate the context to generate a personal assistant result. The secondary device is configured to receive the personal assistant result from the primary device. The secondary device is configured to present the personal assistant result to the user.

According to an aspect of the instant disclosure, a method for remotely providing personal assistant information through a secondary device is provided. The method includes establishing, by a primary device, a communication channel with a secondary device. A context, associated with a user, is received by the primary device. Digital personal assistant functionality is invoked, by the primary device, to evaluate the context to generate a personal assistant result. The personal assistant result is provided, by the primary device, to the secondary device for presentation to the user.

According to an aspect of the instant disclosure, a means for remotely providing personal assistant information through a secondary device is provided. A communication channel is established with a secondary device, by the means for remotely providing personal assistant information. A context, associated with a user, is received, by the means for remotely providing personal assistant information. Digital personal assistant functionality is invoked to evaluate the context to generate a personal assistant result, by the means for remotely providing personal assistant information. The personal assistant result is provided to the secondary device for presentation to the user, by the means for remotely providing personal assistant information.

According to an aspect of the instant disclosure, a means providing personal assistant information remotely received from a primary device. A context associated with a user is detected, by the means for providing personal assistant information. A communication channel is established with a primary device, by the means for providing personal assistant information. A message is sent to the primary device, by the means for providing personal assistant information. The message comprises the context and an instruction for the primary device to invoke digital personal assistant functionality to evaluate the context to generate a personal assistant result. The personal assistant result is received from the primary device, by the means for providing personal assistant information. The personal assistant result is presented to the user, by the means for providing personal assistant information.

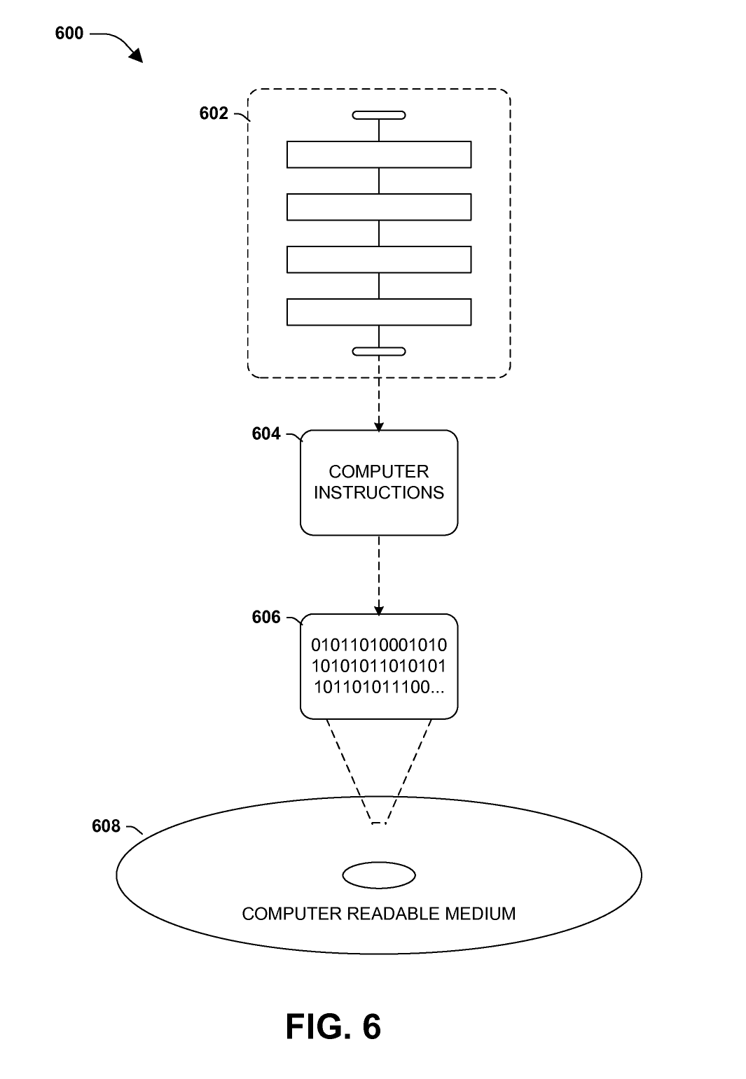

Still another embodiment involves a computer-readable medium comprising processor-executable instructions configured to implement one or more of the techniques presented herein. An example embodiment of a computer-readable medium or a computer-readable device is illustrated in FIG. 6, wherein the implementation 600 comprises a computer-readable medium 608, such as a CD-R, DVD-R, flash drive, a platter of a hard disk drive, etc., on which is encoded computer-readable data 606. This computer-readable data 606, such as binary data comprising at least one of a zero or a one, in turn comprises a set of computer instructions 604 configured to operate according to one or more of the principles set forth herein. In some embodiments, the processor-executable computer instructions 604 are configured to perform a method 602, such as at least some of the exemplary method 100 of FIG. 1, for example. In some embodiments, the processor-executable instructions 604 are configured to implement a system, such as at least some of the exemplary system 201 of FIGS. 2A and 2B, at least some of the exemplary system 300 of FIG. 3, at least some of the exemplary system 400 of FIG. 4, and/or at least some of the exemplary system 500 of FIG. 5, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

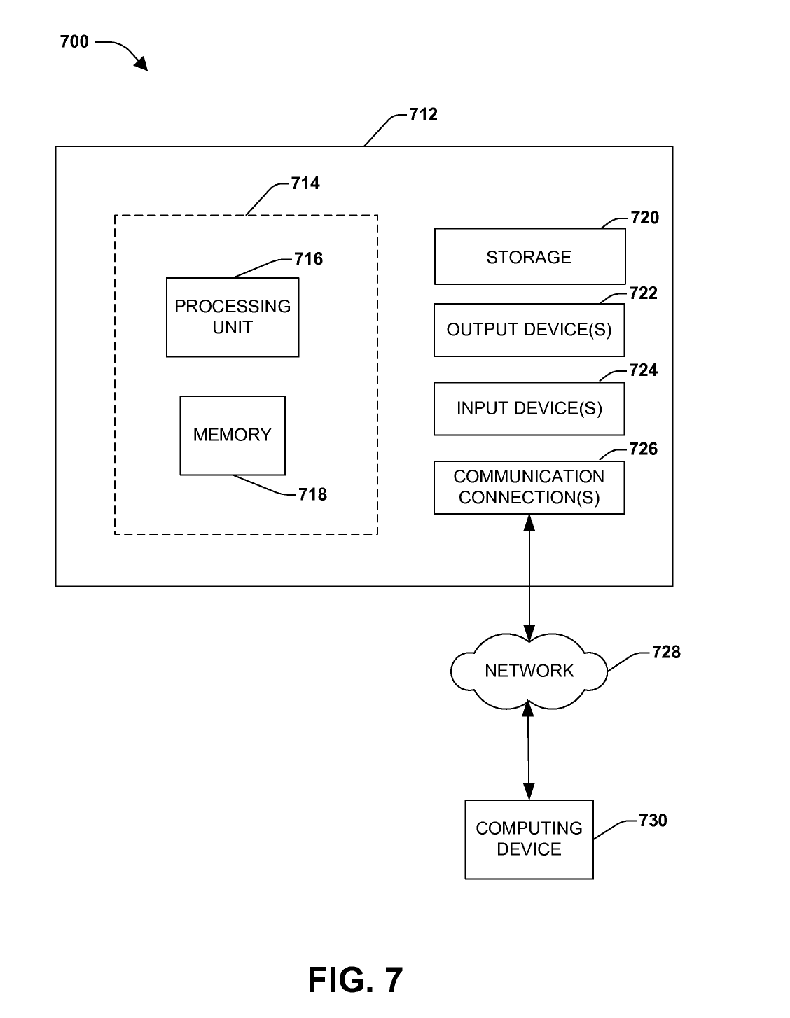

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 700 comprising a computing device 712 configured to implement one or more embodiments provided herein. In one configuration, computing device 712 includes at least one processing unit 716 and memory 718. Depending on the exact configuration and type of computing device, memory 718 may be volatile (such as RAM, for example), non-volatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In one embodiment, computer readable instructions to implement one or more embodiments provided herein may be in storage 720. Storage 720 may also store other computer readable instructions to implement an operating system, an application program, and the like. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Computer storage media does not, however, include propagated signals. Rather, computer storage media excludes propagated signals. Any such computer storage media may be part of device 712.

Device 712 may also include communication connection(s) 726 that allows device 712 to communicate with other devices. Communication connection(s) 726 may include, but is not limited to, a modem, a Network Interface Card (NIC), an integrated network interface, a radio frequency transmitter/receiver, an infrared port, a USB connection, or other interfaces for connecting computing device 712 to other computing devices. Communication connection(s) 726 may include a wired connection or a wireless connection. Communication connection(s) 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device(s) 724 such as keyboard, mouse, pen, voice input device, touch input device, infrared cameras, video input devices, and/or any other input device. Output device(s) 722 such as one or more displays, speakers, printers, and/or any other output device may also be included in device 712. Input device(s) 724 and output device(s) 722 may be connected to device 712 via a wired connection, wireless connection, or any combination thereof. In one embodiment, an input device or an output device from another computing device may be used as input device(s) 724 or output device(s) 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 712 may be interconnected by a network. For example, memory 718 may be comprised of multiple physical memory units located in different physical locations interconnected by a network.

Those skilled in the art will realize that storage devices utilized to store computer readable instructions may be distributed across a network. For example, a computing device 730 accessible via a network 728 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A system for remotely providing personal assistant information through a secondary device, comprising:
a primary device configured to:
establish a communication channel with a secondary device;
receive a context associated with a user;
invoke digital personal assistant functionality to evaluate the context to generate a personal assistant result; and
provide the personal assistant result to the secondary device for presentation to the user.

2. The system of claim 1, the primary device configured to:
receive the context from the secondary device.

3. The system of claim 1, the primary device configured to:
detect the context through the primary device.

4. The system of claim 1, the context comprising at least one of audio data, video data, imagery, or sensor data.

5. The system of claim 1, the primary device configured to:
invoke the secondary device to display the personal assistant result through the secondary device.

6. The system of claim 1, the primary device configured to:
invoke the secondary device to play the personal assistant result through the secondary device.

7. The system of claim 1, the digital personal assistant functionality not hosted on the secondary device.

8. The system of claim 1, the primary device configured to:
receive interactive user feedback for the personal assistant result from the secondary device;
invoke the digital personal assistant functionality to evaluate the interactive user feedback to generate a second personal assistant result; and
provide the second personal assistant result to the secondary device for presentation to the user.

9. The system of claim 1, the secondary device comprising at least one of an appliance, a television, an audio visual device, a vehicle device, a wearable device, a non-personal assistant enabled device.

10. The system of claim 1, the primary device configured to:
receive an audio file, from the secondary device, as the context;
perform speech recognition on the audio file to generate a user statement context;
invoke the digital personal assistant functionality to evaluate the user statement context to generate the personal assistant result.

11. The system of claim 1, the primary device configured to:
invoke the secondary device to present the personal assistant result through a first digital personal assistant user interface hosted on the secondary device;
receive a local user context through the primary device, the local user context different than the context;
invoke the digital personal assistant functionality to evaluate the local user context to generate a second personal assistant result; and
provide the second personal assistant result, concurrently with the first digital personal assistant user interface being presented through the secondary device, for presentation through a second digital personal assistant user interface hosted on the primary device.

12. The system of claim 1, the primary device configured to:
provide the personal assistant result as a text to speech string.

13. The system of claim 1, the primary device configured to:
responsive to detecting an error condition, include an error string within the personal assistant result.

14. The system of claim 1, the personal assistant result comprising at least one of an audio message, a text string, an image, a video, a website, task completion functionality, or a recommendation.

15. A system for providing personal assistant information remotely received from a primary device, comprising:
a secondary device configured to:
detect a context associated with a user;
establish a communication channel with a primary device;
send a message to the primary device, the message comprising the context and an instruction for the primary device to invoke digital personal assistant functionality to evaluate the context to generate a personal assistant result;
receive the personal assistant result from the primary device; and
present the personal assistant result to the user.

16. The system of claim 15, the secondary device configured to:
retrieve a first party speech app from an app store;
deploy the first party speech app on the secondary device; and
invoke the first party speech app to detected the context.

17. The system of claim 15, the secondary device configured to:
define a context recognition enablement policy;
responsive to the context recognition enablement policy being satisfied by a current situation context, detect the context; and
responsive to the context recognition enablement policy not being satisfied by the current situation context, ignore the context.

18. The system of claim 15, the secondary device configured to:
send the context as audio data recorded from the user;
receive the personal assistant result as a text to speech string; and
play the text to speech string to the user.

19. The system of claim 15, the secondary device configured to:
display at least one of an image, a video, a text string, a website, task completion functionality, or a recommendation based upon the personal assistant result.

20. A method for remotely providing personal assistant information through a secondary device, comprising:
establishing, by a primary device, a communication channel with a secondary device;
receiving, by the primary device, a context associated with a user;
invoking, by the primary device, digital personal assistant functionality to evaluate the context to generate a personal assistant result; and
providing, by the primary device, the personal assistant result to the secondary device for presentation to the user.
